(19) United States
(12) Patent Application Publication
(10) Pub. No.: US 2005/0027599 A1
(43) Pub. Date: Feb. 3, 2005

(54) Content delivery and storage system and method

(76) Inventors: William John McAndrews Boyd, Castle Rock, CO (US); Steven Henry Miller, Castle Rock, CO (US); Paul Kenneth Zorn, Highlands Ranch, CO (US); Ernest Marion Duckworth III, Littleton, CO (US); Christopher Steven Miller, Parker, CO (US); Jeffrey Donald Pullara, Castle Rock, CO (US); Julie Ann Zimmerman, Castle Rock, CO (US)

Correspondence Address: LAW OFFICE OF DALE B. HALLING, 24 s. WEBER ST., SUITE 311, COLORADO SPRINGS, CO, 80903, US

(21) Appl. No.: 10/902,613

(22) Filed: Jul. 29, 2004

Related U.S. Application Data
(60) Provisional application No. 60/491,441, filed on Jul. 31, 2003.

(51) Int. Cl. G06F 17/60

(52) U.S. Cl. 705/14

(57) ABSTRACT

A content delivery and storage system includes an advertising delivery system that transmits an advertisement to a broadcast advertising system. The broadcast advertising system places the advertisement on an external web page. The advertisement includes a hyperlink. A third party marketing validation web site having a web page is coupled to the hyperlink.

### RELATED APPLICATIONS

The present invention claims priority on provisional patent application, Ser. No. 60/491,441, filed on Jul. 31, 2003, entitled “Press Release Submission Service and Repository”.

### FIELD OF THE INVENTION

The present invention relates generally to the field of content systems and more particularly to a content delivery and storage system and method.

### BACKGROUND OF THE INVENTION

Advertisers have been excited by the possibilities of the World Wide Web or more generally the Internet. Potentially, the Internet allows producers to inexpensively get their message out to a targeted audience. Unfortunately, pop-up advertisements and email advertisements have flooded the Internet in a very indiscriminate fashion. As a result, most consumers have learned to ignore almost all advertising on the Internet. This has effected even more traditional advertisements on home pages.

Thus there exists a need for content delivery and aggregation system that provides a more effective and targeted method of advertising over the Internet.

### SUMMARY OF INVENTION

A content delivery and storage system that overcomes these and other problems includes an advertising delivery system that transmits an advertisement to a broadcast advertising system. The broadcast advertising system places the advertisement on an external web page. The advertisement includes a hyperlink. A third party marketing validation web site having a web page is coupled to the hyperlink. The third party marketing validation web site includes an aggregation system for receiving a content, meeting a content definition from a number of sources. The third party marketing validation web site includes an archival system to permanently storing the content. The third party marketing validation web site may include an indexing system that indexes the content to form an indexed content. The third party marketing validation web site may include a search engine capable of searching the indexed content. The third party marketing validation web site may place each posting of the content into a category. The third party marketing validation web site may have a home page that updates the most recent postings of the content at a predefined interval. The web page of the third party marketing validation may have a second advertisement. The aggregation system may receive an electronic posting as part of the content.

In one embodiment, a content delivery and storage system, includes an advertising delivery system that transmits an information advertisement to an external web page. The advertisement has a hyperlink. A third party marketing validation web site has a web page coupled to the hyperlink. The web page contains a traditional advertisement. The third party marketing validation web site aggregates a number of postings of content meeting a content definition. The third party marketing validation web site may have wizard for creating the informational advertisement or for creating a posting of content. The information advertisement may include a second hyperlink to an advertiser's web site. An owner of the advertiser's web site may be the owner of the informational advertisement.

In one embodiment, a content delivery and storage method, includes the steps of placing an information advertisement on an external web site. The informational advertisement has a hyperlink. When the hyperlink is activated, a web page of a third party marketing validation web site is displayed. A traditional advertisement may be placed in the web page that contains a second hyperlink. When the second hyperlink is activated, an advertiser's web site is displayed. A number of postings of content meeting a content definition from a number of sources are aggregated. Every word of the posting of content may be indexed.

### BRIEF DESCRIPTION OF THE DRAWINGS

FIG. 1 is a block diagram of a content delivery and storage system in accordance with one embodiment of the invention;

FIG. 2 is a block diagram of a content delivery and storage system in accordance with one embodiment of the invention;

FIG. 3 is a block diagram of a third party marketing validation web site and content source in accordance with one embodiment of the invention; and

FIG. 4 is a flow chart of the steps used in a content delivery and storage system in accordance with one embodiment of the invention.

### DETAILED DESCRIPTION OF THE DRAWINGS

In order to understand the foregoing description and claims the definitions of the following words must be known. As a result, these definitions are provided to help the readers' understanding and to clarify the meaning of these terms as used herein.

Definitions

Third Party marketing validation web site: is a web site that is independent of the entity advertising in the advertisement and provides content that is not an advertisement.

Content definition: is a broad category of content such as press releases, editorials, job posting and resumes, etc.

Predefined interval: is between 1 second and 1 hour, in one embodiment it is every 6 seconds.

Hyperlink: is an electronic link to another electronic source of information.

Information advertisement: is an advertisement for more information.

Traditional advertisement: is an advertisement for a purchase of a product or service and usually contains items such a price. It is commonly a request for an offer for sale. It may also be a call button, a lead capture, web show etc.

Second hyperlink: is just a way of distinguishing two different hyperlinks.

External web site: is a web site that is not part of the third party marketing validation web site or the advertiser's web site.

Informational content: This is content such as an article that provides information of general interest to the reader as opposed to purchasing information such as price, product specification, ordering or purchasing information. Examples of information content are newspaper articles (electronic or paper), press releases and editorials.

System Description

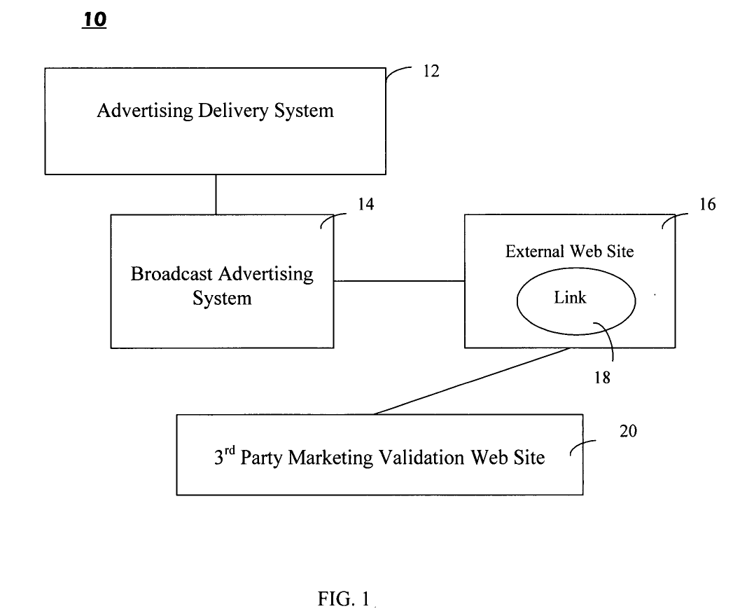

FIG. 1 is a block diagram of a content delivery and storage system 10 in accordance with one embodiment of the invention. The system 10 has an advertising delivery system 12 that transmits an advertisement to a broadcast system 14. The broadcast advertising system 14 transmits the advertisement to an external web site 16. Generally, the broadcast advertising system 14 transmits the advertisement to numerous external web sites 16. In one embodiment, the advertisement is an information advertisement. An information advertisement entices the reader to ask for more information about a company or product, it does not ask the reader to buy anything. In one embodiment the information advertisements include a header or footer that represents the advertisement as an informational advertisement. The advertisement may be a pop under advertisement, a banner advertisement, a column advertisement or any other advertisement used with web sites. The advertisement includes a hyperlink 18 to a third party marketing validation web site 20. A third party marketing validation web site 20 is a web site that is not controlled by the advertiser. A third party marketing validation web site 20 is a web site that provides information content. The hyperlink 18 connects the viewer with informational content such as an article on the subject. An example of an information advertisement might state “click here to read about how brand X SUV (Sports Utility Vehicle) performed on a recent trip to Moab, Utah”. When the user clicked on the hyperlink 18 in information advertisement, the user would be taken to an article or editorial at the third party marketing validation web site 20. The article would then describe how brand X SUV performed on the trip to Moab, Utah. The third party marketing validation web site 20 holds information content, so it is similar to Yahoo or newspaper's web site. As a result, the reader (viewer) trusts the information more than a traditional advertisement. It is an independent third party provider of information that as a result validates the marketing information in the article.

Advertiser's want third party market validation for their products. Third party validation is more effective and credible than traditional advertisements. No previous systems have been designed to allow an advertiser to purposely setup a third party market validation over the Internet.

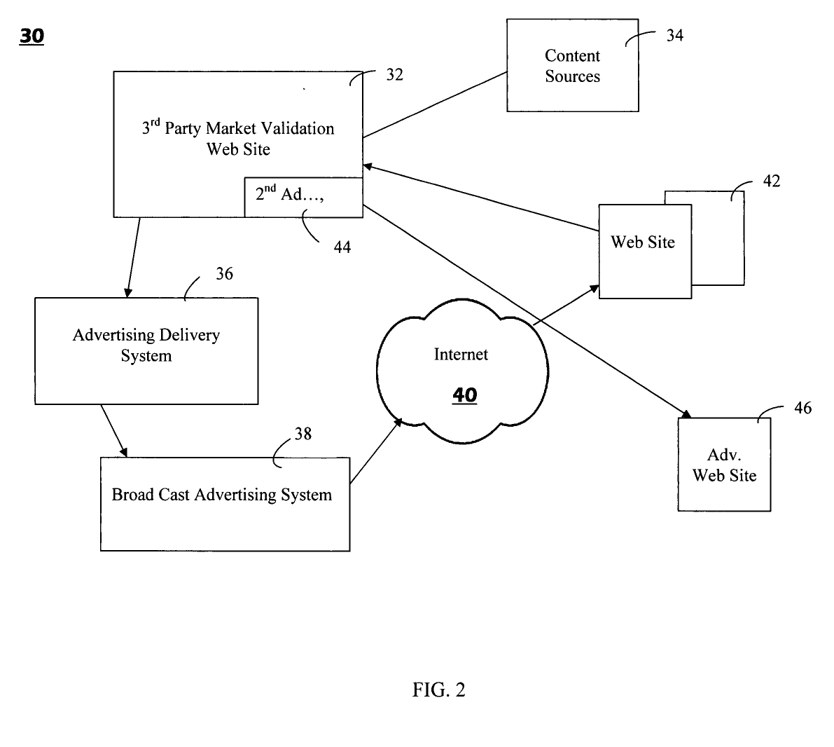

FIG. 2 is a block diagram of a content delivery and storage system 30 in accordance with one embodiment of the invention. The system 30 has a third party marketing validation web site 32 coupled to a number of content sources 34. The third party marketing validation web site 32 aggregates content from a plurality of content source 34. The third party marketing validation web site 32 then hosts this information for users (browsers). As a result, the third party marketing validation web site 32 is an informational web site and is viewed by readers as an independent provider of information. By independent it is meant that the web site does not just contain advertisements or the equivalent of infomercials. The third party marketing validation web site 32 is coupled to an advertising delivery system 36. The advertising delivery system 36 is just a system to deliver advertisements to a broadcast advertising system 38 from the creator of the advertisement. In one embodiment, the broadcast advertising system 38 and the advertising delivery system 36 may be one and the same. An example of a broadcast advertising system is Value Click. The broadcast advertising system 38 is connected to the Internet 40. Note that the connections between all the blocks may be through the Internet 40. The broadcast advertising system 38 transmits advertisements to external web sites 42. An information advertisement on the external web sites 42 have a hyperlink to the third party marketing validation web site 32. The hyperlink will cause a posting of content to be displayed on a user's computer screen. Along with the posting of content may be a traditional advertisement 44. The owner of the information advertisement displayed on the external web site may be the same as the owner of the traditional advertisement. The traditional advertisement 44 may contain a hyperlink to the advertiser's web site 46. This system 30 allows an advertiser to have multiple points of contact with the consumer before the consumer is asked to purchase a product or service. The first contact is the information advertisement on the external web site 42. The next point of contact may be the posting of content such as an editorial or press release on the third party marketing validation web site 32. Along with the posting of content may be a traditional advertisement. The traditional advertisement on the third party marketing validation web site 32 is the third point of contact with the consumer. If the consumer then visits the advertiser's web site 46, this is the fourth point of contact. As a result, the consumer is usually ready to buy when they visit the advertiser's web site, store or call center. In addition, the consumer has first been provided relevant information content before they are asked to purchase anything. This enforces the feeling that the advertiser's products or services really meet the consumer's needs. The system 30 provides a more effective and targeted method of advertising over the Internet.

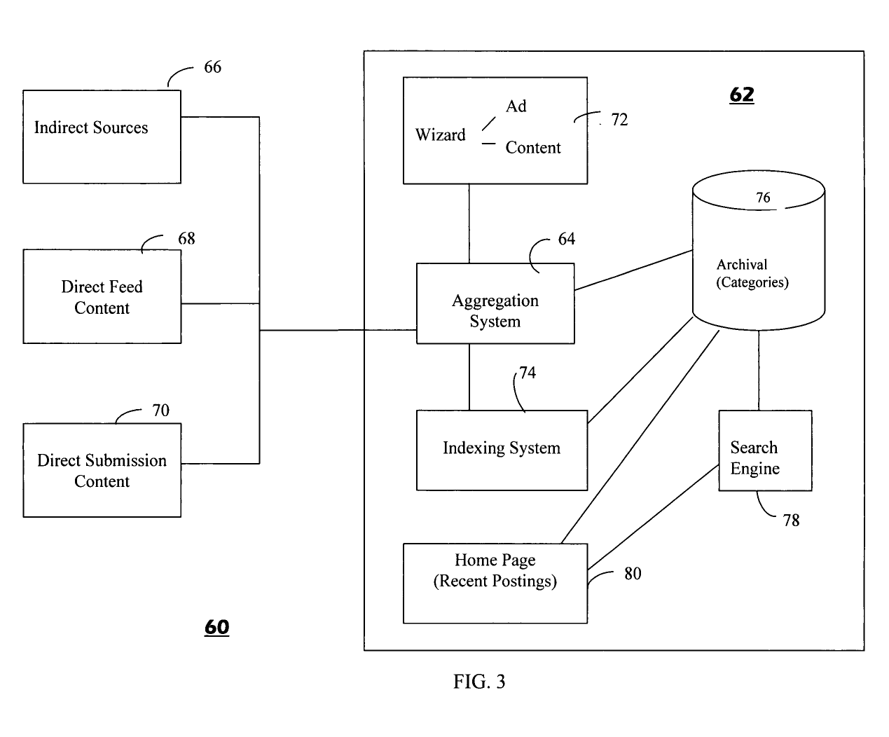

FIG. 3 is a block diagram of a third party marketing validation web site and content source 60 in accordance with one embodiment of the invention. The third party marketing validation web site 62 has an aggregation system 64 that interfaces with a number of sources of content. One source of content is indirect sources 66. An indirect source 66 is a source from which the aggregation system 64 pulls postings of content that meet a content definition into the third party marketing validation web site 62. The content definition may be press releases, editorials, sports, career information, etc. Another source of content is direct feed content 68. Direct feed content is content directly from the creator and is usually an organization that creates content meeting the content definition regularly. For instance, a government organization may regularly issue press releases. A third source of content is direct submission content 70. Direct submission content 70 is content that is pushed into the third party marketing validation web site 62 by a source that infrequently has content postings. For instance, a start-up company may only occasionally issue press releases. When a posting is received from a direct submission content provider, the provider is contacted independent of the submission to verify that the author of the posting is authentic. A wizard 72 helps a direct submission content provider to create content that is appropriate and meets their goals. The wizard 72 may also be used to create an information content advertisement.

Once the postings of content are received they may be indexed by an indexing system 74. In addition, the content may be placed in categories. For instance, press releases may be categorized into government, technology, automotive, etc. The posting of content are also archived by an archiving system 76. They may be archived by categories. In one embodiment, the postings are archived permanently. This allows the information in the postings to be searched for research projects. As a result, the archival system 76 is coupled to a search engine 78. The search engine 78 includes a system for skipping to the 10^{th}, 100^{th}, 1000^{th}, etc posting. This is unique, in that most systems allows to skip to the next page but not a certain listing. This increases the usefulness of the search results. The archival system 76 is also coupled to a home page 80 of third party marketing validation web site 62. The home page 80 is organized to show the most recent posting of content by category. The most recent posting are updated periodically. For instance, in one embodiment they are updated every six seconds. Continuous updating requires multiple feeds to create the home page and may result in slower display of the home page.

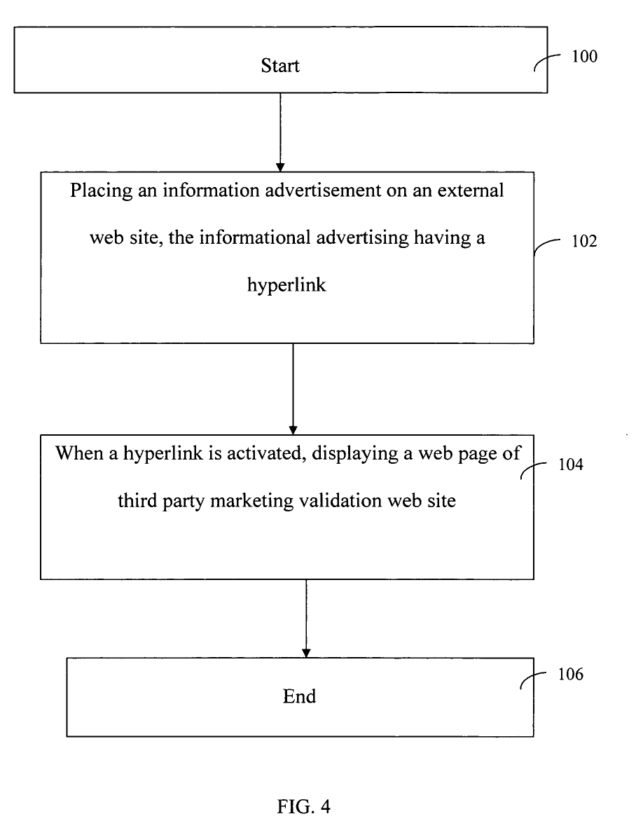

FIG. 4 is a flow chart of the steps used in a content delivery and storage system in accordance with one embodiment of the invention. The process starts, step 100, by placing an information advertisement on an external web site at step 102. The information advertisement has a hyperlink. When the hyperlink is activated at step 104, a web page of a third party marketing validation web sites displayed which ends the process at step 106. A traditional advertisement may be placed in the web page that contains a second hyperlink. When the second hyperlink is activated, an advertiser's web site is displayed. A number of postings of content meeting a content definition from a number of sources are aggregated. Every word of the posting of content may be indexed.

Thus there has been described a content aggregation and delivery system that provides a more targeted and effective means for advertising over the Internet.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

1. A content delivery and storage system, comprising:
an advertising delivery system transmitting an advertisement to a broadcast advertising system which places the advertisement on an external web page, the advertisement having a hyperlink; and
a third party marketing validation web site with a web page coupled to the hyperlink.

2. The system of claim 1, wherein the third party marketing validation web site includes an aggregation system receiving a plurality of content meeting a content definition from a plurality of sources.

3. The system of claim 2, wherein the third party marketing validation web site includes an archival system permanently storing the plurality of content.

4. The system of claim 2, wherein the third party marketing validation web site includes an indexing system that indexes the plurality of content to form an indexed content.

5. The system of claim 4, wherein the third party marketing validation web site includes a search engine capable of searching the indexed content.

6. The system of claim 3, wherein the third party marketing validation web site places each posting of the plurality of content into a category.

7. The system of claim 6, wherein the third party marketing validation web site has a home page that updates a most recent postings of the plurality of content at a predefined interval.

8. The system of claim 7, wherein the web page of the third party marketing validation has a second advertisement.

9. The system of claim 2, wherein the aggregation system receives an electronic posting as part of the plurality of content.

10. A content delivery and storage system, comprising:
an advertising delivery system transmitting an information advertisement to an external web page, the informational advertisement having a hyperlink; and
a third party marketing validation web site with a web page coupled to the hyperlink, the web page containing a traditional advertisement.

11. The system of claim 10, wherein the third party marketing validation web site aggregates a plurality of postings of content meeting a content definition.

12. The system of claim 11, further including a wizard for creating the informational advertisement.

13. The system of claim 11, further including a wizard for creating a posting of content of the plurality of postings of content.

14. The system of claim 10, wherein the traditional advertisement includes a second hyperlink to an advertiser's web site.

15. The system of claim 14, wherein an owner of the advertiser's web site is the owner of the informational advertisement.

16. A content delivery and storage method, comprising the steps of:
a) placing an information advertisement on an external web site, the informational advertisement having a hyperlink; and
b) when the hyperlink is activated, displaying a web page of a third party marketing validation web site.

17. The method of claim 16, further including the step of:
c) placing a traditional advertisement in the web page containing a second hyperlink.

18. The method of claim 17, further including the step of:
d) when the second hyperlink is activated, displaying an advertiser's web site.

19. The method of claim 16, wherein step (b) further includes the step of:
b1) aggregating a plurality of postings of content meeting a content definition from a plurality of sources.

20. The method of claim 19, further including the step of:
b2) indexing every word of each of the plurality of posting of content.
